(19) United States
(12) Patent Application Publication
(10) Pub. No.: US 2023/0338211 A1
(43) Pub. Date: Oct. 26, 2023

(54) MODULAR BED FOR A PATIENT

(71) Applicant: Srilatha Dwaram, Hyderabad (IN)

(72) Inventor: Srilatha Dwaram, Hyderabad (IN)

(21) Appl. No.: 18/025,657

(22) PCT Filed: Apr. 18, 2022
(86) PCT No.: PCT/IN22/50370

§ 371 Date: Mar. 10, 2023

(30) Foreign Application Priority Data
Apr. 21, 2021 (IN) 20211018484

(51) Int. Cl. A61G 7/015; A61G 7/018

(52) U.S. Cl. CPC A61G 7/015; A61G 7/018

(57) ABSTRACT

A modular bed (100) comprising a main frame (102), a midline spine (104), a first subframe (108) and a second subframe (110) mounted within the main frame (102), a first pair of flaps (114) and a second pair of flaps (116) mounted within the second subframe (110), and a set of flaps (118) is disclosed. The first subframe (108) and the second subframe (110) are mounted on either side of the midline spine (104) and are configured to move laterally. Further, the first pair of flaps (114) and the second pair of flaps (116) are capable of sliding along the longitudinal central axis (106). Further, the set of flaps (118) are within the main frame (102) coupled to either side of the midline spine (104) through a hinge (120) and capable of an individual lateral movement.

### PRIORITY INFORMATION

The present application claims priority from Indian patent application no. 202141018484 filed on 21 Apr. 2021.

### TECHNICAL FIELD

The present subject matter described herein, in general, relates to a bed. More particularly to a modular bed for a patient.

### BACKGROUND

Traditionally, people suffering from critical and chronic health disorders are hospitalized to ensure intensive care and attention. Many of the critical diseases affect the ability of a patient to move independently. Consequently, the patient becomes bedridden for a prolonged period during course of treatment. Further, the bedridden patients are required to be moved at regular intervals of time for medication purpose and to change their positions. Generally, the bedridden patients are known to be susceptible for skin ailments caused due to prolonged pressure on skin. Further, the skin ailments such as bed sores or pressure ulcers, increase the criticality of patient's existing illnesses and even affect patient's life expectancy in some instances. Therefore, preventing such skin ailments in the bedridden patients and old aged people incapable of moving independently becomes challenging.

### SUMMARY

Before the present system(s) and method(s), are described, it is to be understood that this application is not limited to the particular system(s), and methodologies described, as there can be multiple possible embodiments which are not expressly illustrated in the present disclosure. It is also to be understood that the terminology used in the description is for the purpose of describing the particular implementations or versions or embodiments only and is not intended to limit the scope of the present application. This summary is provided to introduce aspects related to a system and a method for a modular bed for a patient. This summary is not intended to identify essential features of the claimed subject matter nor is it intended for use in determining or limiting the scope of the claimed subject matter.

In one implementation, a modular bed for a patient is disclosed. The modular bed may comprise a main frame. It may be understood that the main frame may be rectangular in shape. Further, the modular bed may comprise a midline spine passing through a longitudinal central axis of the main frame. Furthermore, the modular bed may comprise a first subframe and a second subframe within the main frame. It may be noted that the first subframe and the second subframe may be mounted on either side of the midline spine towards a bottom end of the main frame. The first subframe and the second subframe may be configured to move laterally. Further, the modular bed may comprise a first pair of flaps mounted within the first subframe and a second pair of flaps mounted within the second subframe. It may be understood that the first pair of flaps and the second pair of flaps may be capable of sliding along the longitudinal central axis of the main frame. Finally, the modular bed may comprise a set of flaps capable of an individual lateral movement. It may be noted that the set of flaps may be within the main frame and coupled to either side of the midline spine. Further, each flap may be coupled to the midline spine through a hinge connected to the midline spine.

In another implementation, a method for creating a modular bed for a patient is disclosed. In order to create the modular bed, initially, a main frame may be received, and the main frame may be rectangular in shape. Further, a midline spine passing through a longitudinal central axis of the main frame may be created. Furthermore, a first subframe and a second subframe may be mounted within the main frame on either side of the midline spine, towards a bottom end of the main frame. It may be noted that the first subframe and the second subframe may be configured to move laterally. Further, a first pair of flaps may be mounted within the first subframe and a second pair of flaps may be mounted within the second mainframe. It may be understood that the first pair of flaps and the second pair of flaps may be capable of sliding along the longitudinal central axis of the main frame. Finally, a set of flaps capable of an individual lateral movement may be assembled within the main frame. It may be noted that the set of flaps may be coupled to either side of the midline spine and each flap may be coupled to the midline spine through a hinge connected to the midline spine.

### BRIEF DESCRIPTION OF THE DRAWINGS

The foregoing detailed description of embodiments is better understood when read in conjunction with the appended drawings. For the purpose of illustrating of the present subject matter, an example of a construction of the present subject matter is provided as figures, however, the invention is not limited to the specific method and system for a modular bed, disclosed in the document and the figures.

The present subject matter is described in detail with reference to the accompanying figures. In the figures, the left-most digit(s) of a reference number identifies the figure in which the reference number first appears. The same numbers are used throughout the drawings to refer to various features of the present subject matter.

FIG. 1 illustrates a first top view of a modular bed for a patient, in accordance with an embodiment of the present subject matter.

FIG. 2 illustrates a second top view of a modular bed for a patient, in accordance with an embodiment of the present subject matter.

FIG. 3 illustrates a third top view of a modular bed for a patient, in accordance with an embodiment of the present subject matter.

FIG. 4 illustrates a fourth top view of a modular bed for a patient, in accordance with an embodiment of the present subject matter.

FIG. 5 illustrates a side view of a modular bed for a patient, in accordance with an embodiment of the present subject matter.

FIG. 6 illustrates a method for creating a modular bed for a patient, in accordance with an embodiment of the present subject matter.

The FIGURES depict an embodiment of the present disclosure for purposes of illustration only. One skilled in the art will readily recognize from the following discussion that alternative embodiments of the structures and methods illustrated herein may be employed without departing from the principles of the disclosure described herein.

### DETAILED DESCRIPTION

Some embodiments of this disclosure, illustrating all its features, will now be discussed in detail. The words “receiving,” “mounting,” “assembling,” “coupling”, “fitting”, and “creating”, and other forms thereof, are intended to be open ended in that an item or items following any one of these words is not meant to be an exhaustive listing of such item or items or meant to be limited to only the listed item or items. It must also be noted that as used herein and in the appended claims, the singular forms “a,” “an,” and “the” include plural references unless the context clearly dictates otherwise. Although any system and methods similar or equivalent to those described herein can be used in the practice or testing of embodiments of the present disclosure, the exemplary, system and methods are now described. The disclosed embodiments are merely examples of the disclosure, which may be embodied in various forms.

Various modifications to the embodiment will be readily apparent to those skilled in the art and the generic principles herein may be applied to other embodiments. However, one of ordinary skill in the art will readily recognize that the present disclosure is not intended to be limited to the embodiments described but is to be accorded the widest scope consistent with the principles and features described herein.

The present invention describes a method and a system for creating a modular bed for a patient. Generally, when the patient suffers from prolonged illness requiring long periods of hospitalization is inevitable as the patient requires intensive care and attention. Depending on the severity of illness, most of the prolonged illnesses affect the moving ability of the patient. Particularly, the patients suffering from limb dysfunctions and paralysis find it hard to move on their own. Also, old age patients with less severe disorders find it difficult to move independently. Such conditions cause the patients to be bedridden. All bedridden patients are required to be moved every couple of hours for medication, food, sponging, and other basic essential care. On other hand, the patients with little or no movement are at high risk to suffer from pressure-related skin disorders such as bed sores, ulcers, and similar skin ailments. In order to prevent further complications for the patients already suffering from critical illnesses, a modular bed may be created.

In order to create the modular bed, firstly, a main frame may be received, and the main frame may be rectangular in shape. Post receiving the main frame, a midline spine passing through a longitudinal central axis of the main frame, may be created. It may be understood that the midline spine may pass through the entire length of the main frame dividing the main frame into two symmetrical halves. Further, a first subframe and a second subframe may be mounted within the main frame on either side of the midline spine and towards a bottom end of the main frame. It may be understood that the main frame may two ends of the main frame may be referred to as a top end and the bottom end.

Furthermore, a first pair of flaps may be mounted within the first subframe and a second pair of flaps may be mounted within the second subframe. The first pair of flaps and the second pair of flaps may be capable of sliding along the longitudinal central axis of the main frame. Finally, a set of flaps capable of an individual lateral movement may be assembled within the main frame. It may be noted that the set of flaps may be coupled to either side of the midline spine through a hinge. The hinge may be connected to the midline spine.

It may be understood that the modular bed disclosed in present invention may assist in preventing the health risks for the critically ill patients, old patients and patients incapacitated to move by themselves. While aspects of described system and method for creating the modular bed for the patient may be implemented in any number of different computing systems, environments, and/or configurations, the embodiments are described in the context of the following exemplary system.

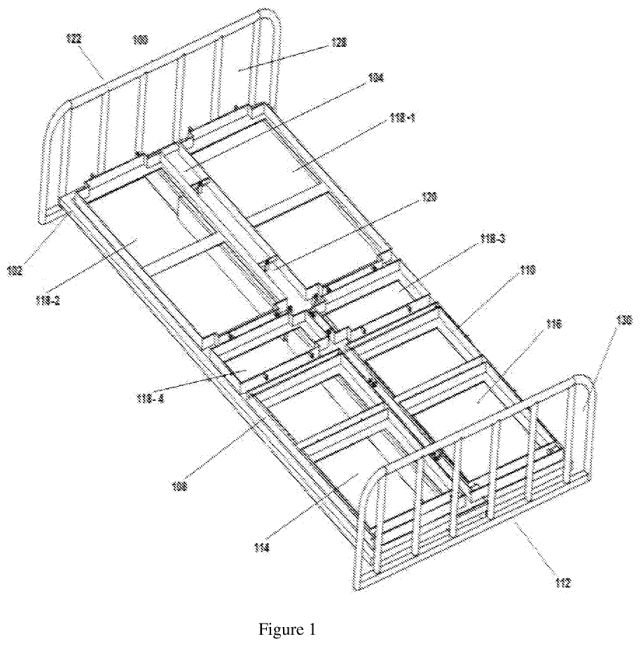

Referring now to FIG. 1, a first top view of a modular bed 100 for a patient is disclosed, in accordance with an embodiment of the present subject matter. The modular bed 100 may be used for hospitalized patients, paralyzed patients, critically ill patients, and patients incapacitated to move independently. It may be understood that the positions of components of the modular bed 100 may be changed as per requirement and may be referred for illustrative purposes. Initially, a main frame 102 may be received. In one embodiment, the main frame 102 may be rectangular in shape. It may be understood that the main frame 102 may also be referred to as an outer bordering structure for the modular bed 100 capable of being attached to; and mounted upon.

Further, a midline spine 104 passing through a longitudinal central axis 106 of the main frame 102 may be created. The midline spine 104 may be understood as a central part running along the length of the main frame dividing the main frame 102 in two symmetrical halves. In one example, the midline spine may act as a linking point for all components of the modular bed 100.

Further, the modular bed 100 may comprise a first subframe 108 and a second subframe 110 mounted within the main frame 102 on either side of the midline spine 104. In one embodiment, the first subframe 108 and the second subframe 110 may be mounted towards a bottom end 112 of the main frame 102. Further, the first subframe 108 and the second subframe 110 may be configured to move laterally in a direction perpendicular to the main frame 102.

In one example, the first subframe 108 and the second subframe 110 may be connected using a hinge 12. Further, the hinge 120 may be mounted on the midline spine 104. It may be understood that the hinge 120 may be connected to the midline spine 104 at one end and to the first subframe 108, or the second subframe 110 at the other end. In other example, the first subframe 108 and the second subframe 110 may be rectangular in shape. In one example, the first pair of flaps 114 and the second pair of flaps 116 may be configured to move laterally along with the first subframe 108 and the second subframe 110 respectively.

Further, the hinge 120 may be understood as a joining structure, attaching two things together while allowing for movement up to 85 degrees. In the modular bed 100, different types of the hinge 120 may be used. Therefore, the hinge 120 may be understood to be at least one of a T-shaped hinge, a C-shaped hinge, and a rigid hinge.

Further, the modular bed 100 may comprise a first pair of flaps 114 mounted within the first subframe 108 and a second pair of flaps 116 mounted within the second subframe. It may be noted that the first pair of flaps 114 and the second pair of flaps 116 may be capable of sliding along the longitudinal central axis 106 of the main frame 102. In one example, the sliding of the first pair of flaps 114 and the second pair of flaps 116 may be facilitated by a roller 134. The roller 134 facilitating the sliding movement may be connected to a long rod 136. In one example, the roller 134 may be mounted below the first pair of flaps 114 and below the second pair of flaps 116.

Further, the modular bed 100 may comprise a set of flaps 118 comprising 118-1, 118-2, 118-3, 118-4, capable of an individual movement within the main frame 102. It may be noted that the set of flaps 118 may be coupled on either side of the midline spine 104. Further, each of the flap may be coupled to the midline spine 104 through the hinge 120. The hinge 120 may be coupled to the main frame 102 at one end and to the set of flaps 118 at the other end. It may be understood that the individual lateral movement of the set of flaps 118 may be brought about at a specific desired angle. In one example, the set of flaps 118 may be on a top end 122 of the main frame 102.

Further, the individual lateral movement of the set of flaps 118 and the sliding of the first pair of flaps 114 and the second pair of flaps 116 may be configured by at least an actuator 132. The actuator 132 may be referred to as a structure responsible for moving and controlling a mechanical arrangement or a mechanical system. It may be understood that the actuator 132 may require a control signal and a source of energy to move. In one example, the actuator 132 may comprise but not be limited to a rotary actuator, a linear actuator, a hydraulic actuator, a pneumatic actuator, and a magnetic actuator. In another embodiment, the lateral movement and the sliding movement may be achieved manually.

Furthermore, the modular bed 100 may comprise a bed base 124 housing the main frame 102. The bed base 124 may comprise a pair of boards 126 located perpendicularly at each of the end of the main frame 102. It may be noted that the board used to rest head of the patient may be referred to as a headboard 128 and the board towards the patient's legs may be referred to as a leg board 130.

Consider an example of a private hospital having a capacity of 500 beds. Further, the hospital may be divided into different specialty sections for Intensive Care Unit (ICU), general wards, gynecology unit, and so on. It may be generally understood that most critical patients are shifted to the intensive care unit (ICU) where the doctors and nurses ensure wellness and stability of the patients. Consider the 500 beds hospital initially has 200 patients and later a pandemic such as the Corona infection follows. The patient infected with Corona would require utmost attention depending on the severity of infection and also require minimal contact with the patients as it is a contagious type of infection.

This pandemic situation may lead to surge in the number of patients in the hospital from 200 to 450. The increase in number of patients particularly who require minimal contact but very intensive care may become extremely challenging. In such situations, the number of medical staff members may also require to be increased to meet the growing demand. Therefore, a need for modular bed may arise.

To solve the given problems, a modular bed 100 may be created. Initially, a main frame 102 may be received which may be rectangular in shape. Further, a midline spine 104 may be created through a longitudinal central axis 106 of the main frame 102. The midline spine may pass through entire length of the main frame 102 dividing the main frame 102 in two symmetrical halves.

Further, a first subframe 108 and a second subframe 110 may be arranged within the main frame 102. The first subframe 108 and the second subframe 110 may also be rectangular structures capable of holding a first pair of flaps 114 and a second pair of flaps 116 respectively. In order to offer different types of movements for the patients, the first pair of flaps 114 and the second pair of flaps 116 may be made capable for sliding along the longitudinal central axis 106 of the main frame 102. To achieve the sliding movement, the first pair of flaps and the second pair of flaps may be connected to a roller (134). Further, the first subframe 108 and the second subframe 110 may be capable to move laterally.

Finally, a set of flaps 118 capable of an individual lateral movement may be coupled to either side of the midline spine 104 within the main frame 104. The coupling may be achieved through a hinge 120 connected to the midline spine 104 at one end and the set of flaps on another end.

The main frame 102 may be understood to have a top end and a bottom end. the set of flaps may be coupled to the top end of the main frame, whereas the first subframe and the second subframe may be mounted towards the bottom end.

Further, all components of the modular bed 100 may be joined with a hinge 120 of different types as per requirement. The main frame may then be placed on a bed base 124 housing the main frame 102. The bed base 124 may comprise a pair of boards: a headboard and a leg board. Further, the bed base 124 may also comprise a plurality of legs. Further, the bed base may comprise four or six legs provided with wheels at end of each leg.

Finally, cushions may be added to the set of flaps, the first pair of flaps, and the second pair of flaps. All of the components may be joined through various hinges, t-shaped hinges, c-shaped hinges, and rigid hinges. Further, an actuator may be installed to control the movements. These actuators may comprise linear actuators, rotary actuators, magnetic actuators, pneumatic actuators, and hydraulic actuators.

Finally, the modular bed may be tested after all assembling and connections are completed. Various positions of the modular bed including: a simple flat position of bed, a left side turning position, a right-side turning position, a leg folding position and a park bench sitting position. The simple flat position of the bed may be achieved when the set of flaps 118-1, 118-2, 118-3 and 118-4, the first pair of flaps 114, and the second pair of flaps 116 are arranged in a flat position parallel to the main frame 102.

In one embodiment, the left side turning position may be achieved by raising the set of flaps 118-2, 118-4, and the second pair of flaps 116 within the second subframe 110 at a desired angle. Similarly, for achieving the right-side turning position, the set of flaps 118-1, 118-3, and the first pair of flaps 114 within the first subframe 108 may be raised at the desired angle.

In another embodiment, the leg folding position may allow the patient fold legs while lying with a flat back and the patient may also fold legs while sitting with a straight back perpendicular to the main frame 102. The leg folding position may be achieved while the patient is lying on the main frame 102. More specifically, the set of flaps 118-1, 118-2, 118-3 and 118-4 may remain in the flat position, while the first pair of flaps 114 and the second pair of flaps 116 may be folded inside the first subframe 108 and the second subframe 110. The folding of the first pair of flaps 114 and the second pair of flaps 116 may be brought about by the sliding mechanism.

In yet another embodiment, the park bench position may be achieved by lateral movement of the set of flaps 118-1, 118-3 and the first pair of flaps 114.

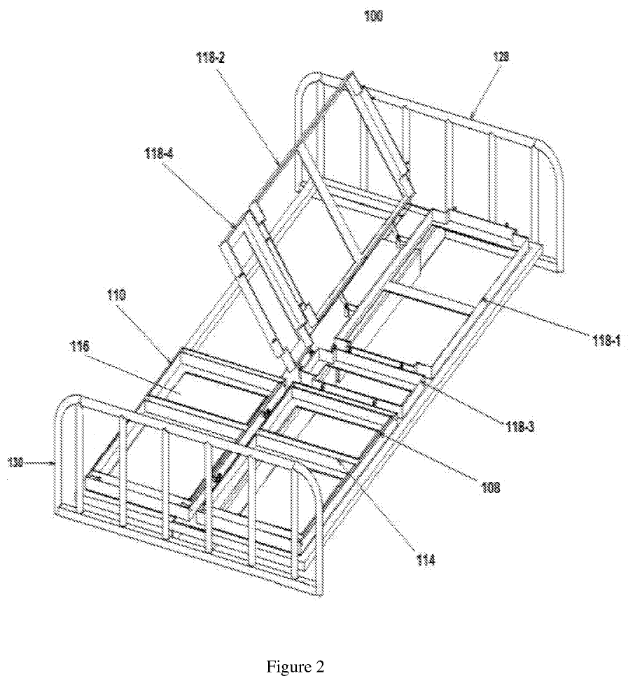

Referring now to FIG. 2, a second top view of a modular bed for a patient, is disclosed in accordance with an embodiment of the present subject matter. The FIG. 2 shows the top view of the modular bed with a set of flaps 118-2 and 118-4 raised laterally. Further, a remaining set of flaps 118-1 and 118-3 may be seen in a flat position. A first subframe 108 and a second subframe 110 comprising a first pair of flaps 114 and a second pair of flaps 116 respectively may also be seen in flat position. In one example, the position disclosed in FIG. 2 may be used to partially move the patient sideways on the left arm of the patient. It may be understood that similarly, remaining set of flaps may also be raised through an individual lateral movement.

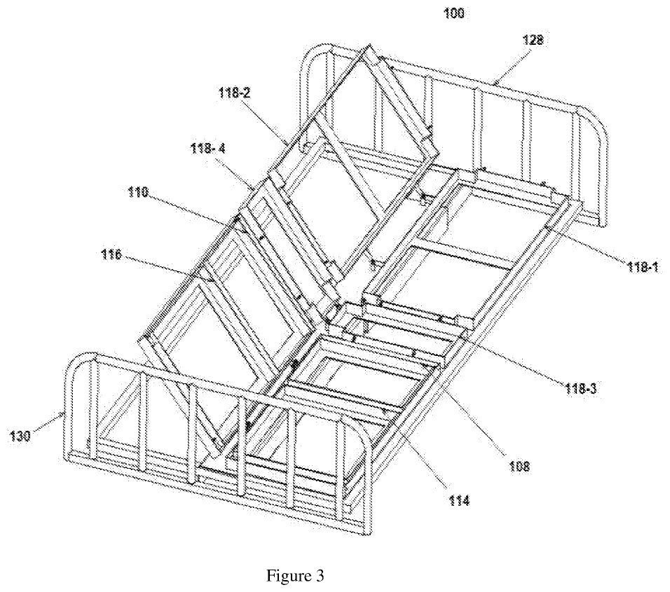

Referring now to FIG. 3, a third top view of a modular bed for a patient is disclosed in accordance with an embodiment of the present subject matter. The FIG. 3 shows the top view of the modular bed with a set of flaps 118-2, 118-4, and a second pair of flaps 116 raised laterally. Further, a remaining set of flaps 118-1, 118-3, and a first pair of flaps 114 may be seen in flat position. In one example, the position shown in FIG. 3 may be used to completely turn the patient sideways on the left arm and left leg of the patient. It may be understood that similarly, the remaining set of flaps 118-1, 118-3, and the first pair of flaps 114 may also be raised through an individual lateral movement to turn the patient on the right arm and right side.

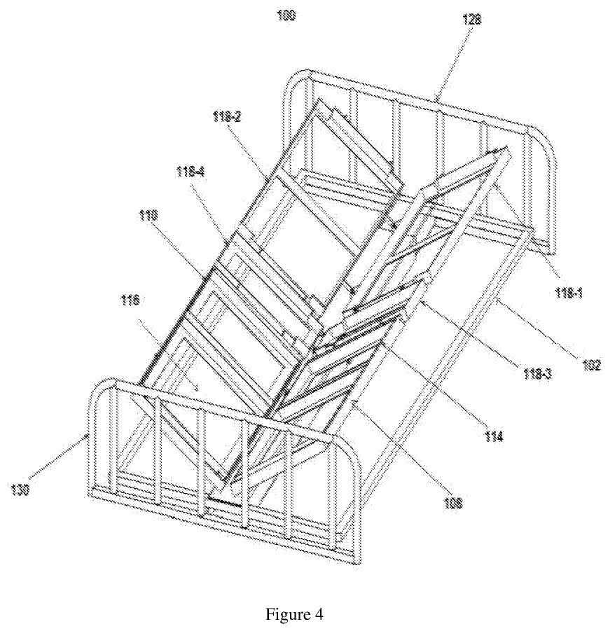

Referring now to FIG. 4, a fourth top view of a modular bed for a patient is disclosed in accordance with an embodiment of the present subject matter. The FIG. 4 shows the top view of the modular bed with an entire set of flaps 118-1, 118-2, 118-3, 118-4, a first pair of flaps 114 and a second pair of flaps 116 raised laterally. Further, the main frame 102 may be seen in entirety.

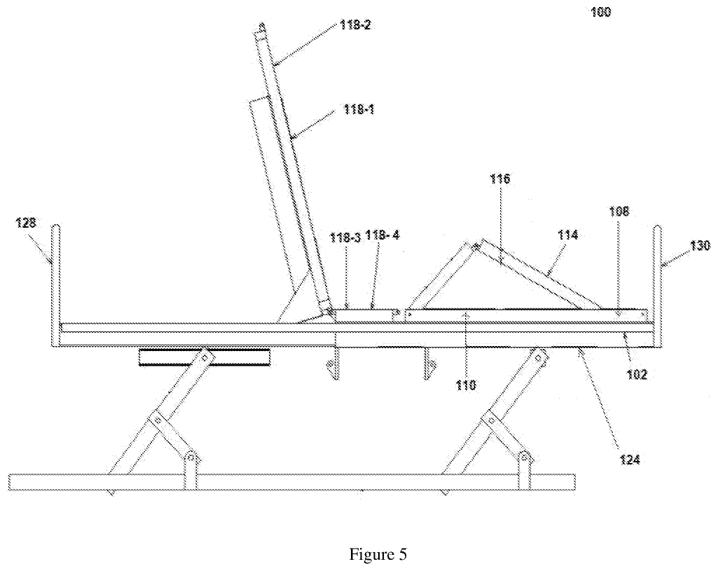

Referring now to FIG. 5, a side view of a modular bed is disclosed in accordance with an embodiment of the present subject matter. The FIG. 5 shows a perpendicularly raised set of flaps 118-1 and 118-2. It may be understood that the perpendicularly raised set of flaps may be used to make a patient sit with straight back support. In one example, the set of flaps 118-1 and 118-2 may also be capable of moving laterally sideways to help the patient turn sideways. It may be understood that either of the set of flaps, 118-1 and 118-2 may be folded when the patient in sitting position may wish to lean on one side. Further, the remaining set of flaps 118-3 and 118-4 may be seen to be in flat in position. Furthermore, a first pair of flaps 114 and a second pair of flaps 116 may be seen in a sliding position while a first subframe 108 and a second subframe 110 may be seen in flat position.

During operation, to achieve the sliding position, a signal may be received by an actuator 132 which may cause a roller 134 and a metal rod 136 attached to the first pair of flaps 114 and the second pair of flaps 116 to move in a way that the a first half of the first pair of flaps 114 near to the leg board 130 side may move upwards toward the head board 128 to push and fold the second half of the first pair of flaps away from the leg board side 130 in order to form the sliding position.

It may be understood that the first pair of flaps 114 and the second pair of flaps 116 may exhibit sliding only until folding in the sliding position and may lock thereafter until a further signal to flatten may be received. In other words, the first pair of flaps 114 and the second pair of flaps 116 may get locked after achieving the sliding position and may not slide any further. It may be noted that the locking of the first pair of flaps 114 and the second pair of flaps 116 may be significant part of the present invention as it may provide stability for the patient on the modular bed 100 and avert any undesirable movement.

In one example, the modular bed 100 may comprise a safety interlock mechanism that may be controlled electronically. Under the safety interlock mechanism three types of interlocks may be provided to enhance the safety of the modular bed 100 in three different positions. A first interlock may prevent the first pair of flaps 114 and the second pair of flaps 116 from undergoing any kind of lateral movement while folded. It may be understood that when the first pair of flaps 114 and the second pair of flaps 116 may be folded, it may lead to folding of the patient's legs. Further, any lateral movement of the first pair of flaps 114 and the second pair of flaps 116 in the folded position may risk the safety of the patient. Therefore, the first interlock may ensure that the first pair of flaps 114 and the second pair of flaps may undergo lateral movement only when each of the flaps may be completely flat and parallel to the modular bed 100.

Further, a second interlock may ensure that the modular bed 100 may not move until all set of flaps 118-1, 118-2, 118-3, 118-4, the first pair of flaps 114 and the second pair of flaps 116 may be in flat position without any elevation.

Furthermore, a third interlock may provide the patient a “go home button” option on a remote-control device to return from any position to a default position wherein the patient may be attended to immediately under medical emergencies. It may be understood that the default position may be achieved by pressing the go home button. Therefore, the third interlock may assist the patient to return to the comfortable default position in any case of discomfort or emergency. In one example, the default position may require all set of flaps 118-1, 118-2, 118-3, 118-4 and the first pair of flaps 114 and the second pair of flaps 116 in flat position. It may be noted that the patient may be able to simply lie down facing upwards in the default position. In another example, the default position may directly assist to carry out Cardiopulmonary resuscitation (CPR) of the patient in cases of emergency. Further, another position may be selected as the default position depending on the type of physical disabilities in the patient.

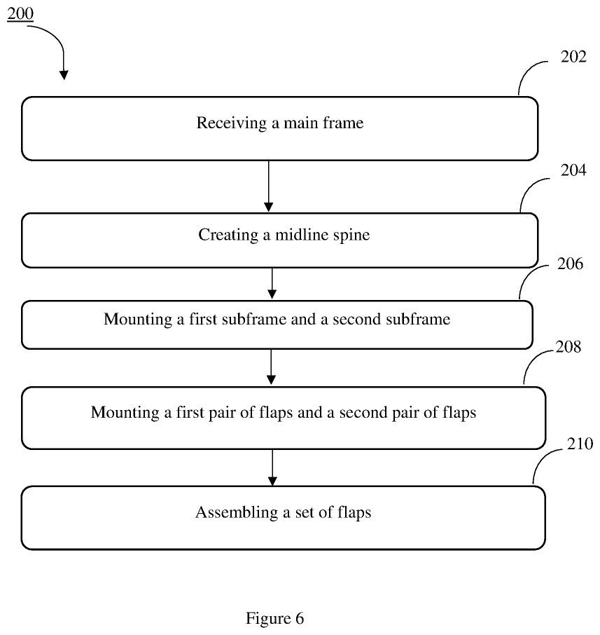

Referring now to FIG. 6, a method 200 for creating a modular bed 100 for a patient is shown, in accordance with an embodiment of the present subject matter. The order in which the method 200 is described is not intended to be construed as a limitation, and any number of the described method blocks can be combined in any order to implement the method 200 or alternate methods for creating a modular bed 100 for a patient.

Additionally, individual blocks may be deleted from the method 200 without departing from the scope of the subject matter described herein. Furthermore, the method 200 creating a modular bed 100 can be implemented in any suitable hardware, software, firmware, or combination thereof. However, for ease of explanation, in the embodiments described below the method 200 may be considered to be implemented as described in the modular bed 100 for the patient.

At block 202, a main frame 102 may be received. In one aspect, the main frame 102 may be rectangular in shape.

At block 204, a midline 104 may be created. In one aspect, the midline spine may be passing through a longitudinal central axis 106 of the main frame 102.

At block 206, a first subframe 108 and a second subframe 110 may be mounted within the main frame 102. In one aspect, the first subframe 108 and the second subframe 110 may be mounted on either side of the midline spine 104 towards a bottom end 112 of the main frame 102 and configured to move laterally.

At block 208, a first pair of flaps 114 may be mounted within the first subframe 108 and a second pair of flaps 116 may be mounted within the second subframe 110. In one aspect, the first pair of flaps 114 and the second pair of flaps 116 may be capable of sliding along the longitudinal central axis 106 of the main frame 102.

At block 210, a set of flaps 118 may be assembled within the main frame 102. In one aspect, the set of flaps 118 may be capable of an individual lateral movement and may be coupled to either side of the midline spine 104, wherein each flap may be coupled to the midline spine 104 through a hinge 120 connected to the midline spine 104.

Further, the method 200 may also comprise coupling the first subframe 108 and the second subframe 110 using the hinge 120, wherein the hinge 120 may be mounted on the midline spine 104.

Exemplary embodiments discussed above may provide certain advantages. Though not required to practice aspects of the disclosure, these advantages may include those provided by the following features.

Some embodiments of the system and the method provide a safe and secure means to timely move bedridden critical patients, paralyzed patients, and patients incapacitated to independently move.

Some embodiments of the system and the method provide a means to prevent skin ailments such as bed sores due to prolonged illness or reduced movements of the patients.

Some embodiments of the system and method provide contactless solution for controlling the movements of the patient infected with communicable and contagious infections.

Some embodiments of the system and method ensure optimal healthcare for patients in intensive care units.

Some embodiments of the system and method reduce the requirement of manpower to support movement of patients from time to time.

Although implementations for methods and system for modular bed for a patient have been described in language specific to structural features and/or methods, it is to be understood that the appended claims are not necessarily limited to the specific features or methods described. Rather, the specific features and methods are disclosed as examples of implementations for creating a modular bed for a patient.

I/We claim:

1. A modular bed (100), comprising:
a main frame (102), wherein the main frame (102) is rectangular in shape;
a midline spine (104) passing through a longitudinal central axis (106) of the main frame (102);
a first subframe (108) and a second subframe (110) within the main frame (102) and are mounted on either side of the midline spine (104) towards a bottom end (112) of the main frame (102), and wherein the first subframe (108) and the second subframe (110) are configured to move laterally;
a first pair of flaps (114) mounted within the first subframe (108) and a second pair of flaps (116) mounted within the second subframe (110), wherein the first pair of flaps (114) are capable of sliding along the longitudinal central axis (106) of the main frame (102); and wherein the second pair of flaps (116) are capable of sliding along the longitudinal central axis (106) of the main frame (102); and
a set of flaps (118) capable of an individual lateral movement, wherein the set of flaps (118) are within the main frame (102), and wherein the set of flaps (118) are coupled to either side of the midline spine (104), and wherein each flap is coupled to the midline spine (104) through a hinge (120) connected to the midline spine (104).

2. The modular bed (100) as claimed in claim 1, wherein the set of flaps (118) are on a top end (122) of the main frame (102).

3. The modular bed (100) as claimed in claim 1, wherein the first subframe (108) and the second subframe (110) are connected using the hinge (120), wherein the hinge (120) is mounted on the midline spine (104).

4. The modular bed (100) as claimed in claim 1, wherein the first subframe (108) and the second subframe (110) are rectangular.

5. The modular bed (100) as claimed in claim 1, wherein the first pair of flaps (114) and the second pair of flaps (116) are configured to move laterally along with the first subframe (108) and the second subframe (110), respectively.

6. The modular bed (100) as claimed in claim 1, wherein the hinge (120) is coupled to the main frame (102) at one end and to the set of flaps (118) on the other end, and wherein the hinge (120) is at least a t-shaped hinge, a rigid hinge, and a c-shaped hinge.

7. The modular bed (100) as claimed in claim 1, wherein the individual lateral movement of the set of flaps (118) and the sliding of the first pair of flaps (114) and the second pair of flaps (116) are configured by at least an actuator (132), and wherein the actuator (132) is a rotary actuator, a linear actuator, a hydraulic actuator, a pneumatic actuator, and a magnetic actuator.

8. The modular bed (100) as claimed in claim 1, further comprises a bed base (124) housing the main frame (102), wherein the bed base (124) comprises a pair of boards (126) located perpendicularly at each of the end of the main frame (102), and wherein one of the boards is a headboard (128) and the other board is a leg board (130).

9. A method (200) for creating a modular bed (100), the method (200) comprises:
receiving a main frame (102), wherein the main frame (102) is rectangular in shape;
creating a midline spine (104) passing through a longitudinal central axis (106) of the main frame (102);
mounting a first subframe (108) and a second subframe (110) within the main frame (102) on either side of the midline spine (104) towards a bottom end (112) of the main frame (102), and configuring the first subframe (108) and the second subframe (110) to move laterally;
mounting a first pair of flaps (114) within the first subframe (108) and a second pair of flaps (116) within the second subframe (110), wherein the first pair of flaps (114) are capable of sliding along the longitudinal central axis (106) of the main frame (102); and wherein the second pair of flaps (116) are capable of sliding along the longitudinal central axis (106) of the main frame (102); and
assembling a set of flaps (118) capable of an individual lateral movement within the main frame (102), wherein the set of flaps (118) are coupled to either side of the midline spine (104), and wherein each flap is coupled to the midline spine (104) through a hinge (120) connected to the midline spine (104).

10. The method (200) as claimed in claim 9, further comprises:
coupling the first subframe (108) and the second subframe (110) using the hinge (120), wherein the hinge (120) is mounted on the midline spine (104).
